(19) United States
(12) Patent Application Publication
(10) Pub. No.: US 2008/0152012 A1
(43) Pub. Date: Jun. 26, 2008

(54) DEVICE AND METHOD FOR CODING MOVING PICTURES

(76) Inventors: Hideyuki OHGOSE, Osaka (JP); Tatsuro Juri, Osaka (JP); Hiroshi Arakawa, Nara (JP); Katsuo Saigo, Hyogo (JP); Koji Arimura, Osaka (JP); Yuki Maruyama, Osaka (JP); Kei Tasaka, Nara (JP)

Correspondence Address: WENDEROTH, LIND & PONACK L.L.P., 2033 K. STREET, NW, SUITE 800, WASHINGTON, DC, 20006, US

(21) Appl. No.: 11/959,707

(22) Filed: Dec. 19, 2007

(30) Foreign Application Priority Data
Dec. 20, 2006 (JP) 2006-342979

(51) Int. Cl. H04N 7/26

(52) U.S. Cl. 375/240.16; 375/E07.105

(57) ABSTRACT

Provided is a moving picture coding device and a moving picture coding method used by the device, which can prevent a search range of reference pictures from being unnecessarily extended when the first coding method is converted into the second coding method. The moving picture coding device codes moving pictures and includes: a decoding unit operable to decode picture data coded by the first coding method; a detection unit operable to detect restriction information out of a part of the picture data coded by the first coding method, the restriction information being used to restrict a reference relationship so that reference is not performed beyond a group of pictures which is processed as one group; a decision unit operable to decide the reference relationship based on the restriction information, when the detection unit detects the restriction information; and a coding unit operable to code the picture data decoded by the decoding unit, by a second coding method and based on the reference relationship decided by the decision unit.

### BACKGROUND OF THE INVENTION

(1) Field of the Invention

The present invention relates to devices and methods for coding moving pictures, and more particularly to a device and method by which pictures coded by the first coding method are re-coded by the second coding method.

(2) Description of the Related Art

In recent years, digital video recorders have been widely used which digitalize analog television broadcasts, then apply compression-coding on the digitalized data, and record the resulting data onto optical disks such as Hard Disk Drive (HDD) and Digital Versatile Disk Random Access Memory (DVD-RAM). Moreover, other digital video recorders are sold which can record digital high-definition broadcasts from satellite broadcasting or terrestrial broadcasting.

For the digital high-definition broadcasts, streams coded by Moving Picture Experts Group (MPEG) 2 standard (hereinafter, referred to as “MPEG-2 streams”) are transmitted.

In order to record such digital high-definition broadcasts, one general method is a method by which the transmitted MPEG-2 streams are directly recorded, or a method by which pictures obtained by decoding MPEG-2 streams are converted into pictures having an image size defined by a DVD standard, and then re-coded by the MPEG-2 standard and recorded. There is another method by which pictures obtained by decoding MPEG-2 streams are re-coded by the H.264 standard which has higher coding efficiency than MPEG-2, and eventually the re-coded pictures are recorded. By the above method, even if the recording is performed by lowering a bit rate of the image size of the digital high-definition broadcast, the picture can be recorded by suppressing deterioration of the image quality. In the H.264 standard, a maximum of 16 pictures can be referred to for motion compensation. Since the MPEG-2 standard allows reference to a maximum of 2 frames (4 fields), the H.264 standard can estimate motion vectors with higher accuracy. In the H.264 standard, however, when motion vector estimation is performed on all reference pictures, the processing amount that is eight times larger than the MPEG-2 standard is required. More specifically, when coding is performed by the H.264 standard, an enormous amount of processing is necessary due to high flexibility of motion compensation and a large number of possible reference pictures. Therefore, a method is proposed which reduces the number of reference pictures, detects more accurate motion vectors, and performs coding (see Japanese Unexamined Patent Application Publication No. 6-78289, for example).

In the picture coding method disclosed in Japanese Unexamined Patent Application Publication No. 6-78289, frame prediction or field prediction is prohibited per slice. In addition, prediction for B pictures from odd-numbered fields to even-ordered fields is prohibited, and forward prediction from odd-numbered fields in reference frames is prohibited, so that the number of reference pictures is reduced.

In the meanwhile, in the MPEG-2 standard, if a closed_gop flag included in a header of a Group of Pictures (GOP) is set to “1”, motion compensation is not performed beyond a GOP boundary (a GOP whose closed_gop flag is “1” is called a closed GOP, while a GOP whose closed_gop flag is not “1” is called an open GOP.). Here, a GOP is data of several pictures which can independently be reproduced. The closed_gop flag is a flag set in a sequence header of a GOP when coding, and represents whether or not first several B pictures in the GOP depend on a preceding GOP, in other words, whether or not the first B pictures are subject to forward prediction.

On the other hand, the H.264 standard does not have the concept of the GOPs. Therefore, when an MPEG-2 stream as a closed GOP is decoded and then simply re-coded using the H.264 standard, pictures which do not inherently need as reference pictures are referred to. That is, there is a problem of unnecessarily extending a range within which reference pictures are searched (hereinafter, referred to as “search range of reference pictures”) and thereby increasing the processing amount of the motion vector estimation.

However, the above-described conventional art disclosed in Japanese Unexamined Patent Application Publication No. 6-78289 does not address the above problem.

Therefore, in view of the above problem, an object of the present invention is to provide a device and method for coding moving pictures (hereinafter, referred to as a “moving picture coding device” and a “moving picture coding method”) which can prevent a search range of reference pictures from being unnecessarily extended when the first coding method is converted into the second coding method.

### SUMMARY OF THE INVENTION

In order to achieve the above object, according to a first aspect of the present invention, provided is a moving picture coding device which codes moving pictures. The device includes: a decoding unit operable to decode picture data coded by a first coding method; a detection unit operable to detect restriction information out of a part of the picture data coded by the first coding method, the restriction information being used to restrict a reference relationship so that reference is not performed beyond a group of pictures which is processed as one group; a decision unit operable to decide the reference relationship based on the restriction information, when said detection unit detects the restriction information; and a coding unit operable to code the picture data decoded by said decoding unit, by a second coding method and based on the reference relationship decided by said decision unit.

With the above structure, when the first coding method is converted into the second coding method, a reference relationship for motion compensation is decided in consideration of restrictions on the first coding method, so that the search range of reference pictures is not unnecessarily extended. Thereby, it is possible to prevent the problem of increasing a processing amount of the motion vector estimation.

Here, said decision unit may decide a parameter which indicates the reference relationship used to estimate a motion vector.

Thereby, by setting parameters in a syntax of the second coding method such as the H.264 standard according to the restrictions on the first coding method such as the MPEG-2 standard, it is possible to decide the reference relationship for motion compensation in consideration of the restrictions on the first coding method even when coding by the second coding method.

Further, said decision unit may decide to set, to an Instantaneous Decoder Refresh picture, a starting picture in coding order in the group of pictures which is processed as one group.

Thereby, the I picture which is a starting picture in coding order in a GOP that is a set of pictures is decided as an IDR picture, so that it is possible to decide the reference relationship for motion compensation in consideration of the restrictions on the first coding method such as the MPEG-2 standard even when coding by the second coding method such as the H.264 standard.

Note that the present invention can be realized not only as the above device, but also as an integrated circuit including the processing units in the device, a method including steps performed by the processing units in the device, a program causing a computer to execute the steps, information, data or signals indicating the program, and the like. Obviously, the program, information, data, and signals may be distributed via recording medium such as CD-ROM or communication medium such as the Internet.

According to the present invention, when the first coding method is converted into the second coding method, a reference relationship for motion compensation is decided in consideration of restrictions on the first coding method, so that a search range of reference pictures is not unnecessarily extended. Thereby, it is possible to realize a moving picture coding device and a moving picture coding method used by the device, which can prevent the problem of increasing a processing amount of the motion estimation.

### FURTHER INFORMATION ABOUT TECHNICAL BACKGROUND TO THIS APPLICATION

The disclosure of Japanese Patent Application No. 2006-342979 filed on Dec. 20, 2006 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing a structure of a moving picture coding device according to the first embodiment of the present invention;

FIG. 2 is a table showing an example of stream information regarding a GOP, such as a GOP header, according to the first embodiment of the present invention;

FIG. 3 is a flowchart for explaining processing in the case of a closed GOP and the case of an open GOP, according to the first embodiment of the present invention;

FIG. 4 is a diagram for explaining an open GOP.

FIG. 5 is a diagram for explaining a closed GOP

FIG. 6 is a schematic diagram showing reference relationships regarding B pictures in the case where a MPEG-2 stream is coded as a frame (picture) structure of the H.264 standard;

FIG. 7 is a schematic diagram showing reference relationships regarding a Br picture and a B picture in the case where a MPEG-2 stream is coded as a frame (picture) structure of the H.264 standard;

FIG. 8 is a schematic diagram showing reference relationships regarding B pictures in the case where a MPEG-2 stream is coded as a field structure of the H.264 standard, and where a closed_gop flag of the MPEG-2 standard is set to “1” (closed GOP);

FIG. 9 is a schematic diagram showing reference relationships regarding a Br picture and a B picture in the case where a MPEG-2 stream is coded as a field structure of the H.264 standard; and

FIG. 10 is a block diagram showing a structure of a moving picture coding device according to the second embodiment of the present invention.

### DESCRIPTION OF THE PREFERRED EMBODIMENT(S)

### First Embodiment

The following describes the first embodiment of the present invention with reference to the drawings.

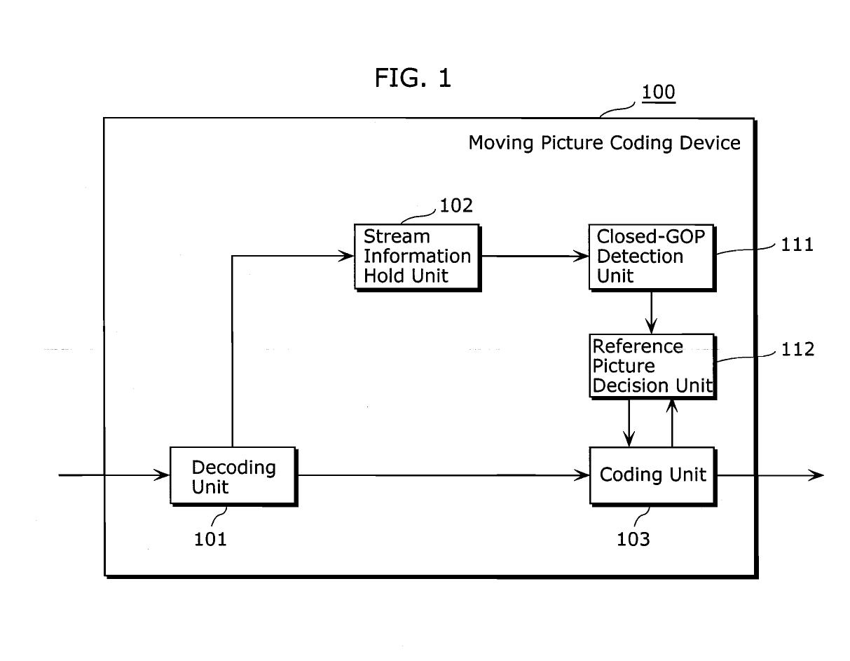

FIG. 1 is a block diagram showing a structure of a moving picture coding device 100 according to the first embodiment of the present invention. As shown in FIG. 1, the moving picture coding device 100 is a device which codes moving pictures, and includes: a decoding unit 101, a stream information hold unit 102, a coding unit 103, a closed-GOP detection unit 111, and a reference picture decision unit 112.

The decoding unit 101 corresponds to a decoding unit according to the present invention which decodes picture data coded by the first coding method. More specifically, when a MPEG-2 stream coded by the first coding method is inputted, the decoding unit 101 decodes the MPEG-2 stream according to a syntax of the MPEG-2 standard. Here, the syntax stands for a rule of data sequence according to the MPEG-2 standard. Furthermore, the decoding unit 101 uses stream information extracted from the MPEG-2 stream in order to generate the decoded picture. The stream information used in the above decoding is, for example, information regarding an entire sequence such as a sequence header, information regarding a GOP such as a GOP header, picture information such as a picture header, slice information such as a slice, macroblock information such as macroblock modes, and the like.

The stream information hold unit 102 holds the extracted stream information. The stream information held in the stream information hold unit 102 is, for example, a bit rate, an image size, a scan scheme, sequence information such as a coding structure, a picture type, motion vector information, information such as a quantization value, and the like.

The closed-GOP detection unit 111 corresponds to a detection unit according to the present invention which detects, out of a part of the picture data coded by the first coding method, restriction information for restricting reference relationships so that reference is not performed beyond a group of pictures which is processed as one set of pictures. More specifically, the closed-GOP detection unit 111 determines whether or not the group of pictures is a closed GOP, based on a closed_gop flag in the stream information held in the stream information hold unit 102.

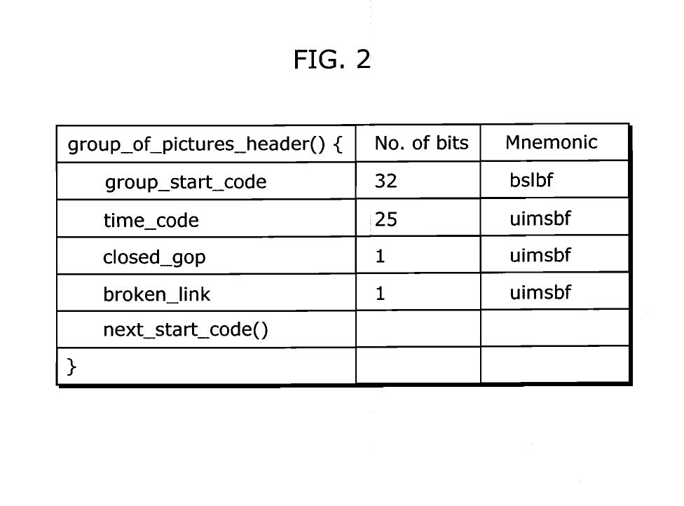

FIG. 2 is a table showing an example of a data structure of a GOP header. If a closed_gop flag, which is indicated in the third row in the GOP header group_of_pictures_header, is set to “1”, it is indicated that the GOP is a closed GOP. On the other hand, if the closed_gop flag is not set to “1”, it is indicated that the GOP is an open GOP.

If the closed-GOP detection unit 111 determines that the GOP is a closed GOP, the closed-GOP detection unit 111 outputs (i) information indicating that the GOP is a closed GOP (information regarding the closed_gop flag) and (ii) the stream information obtained from the stream information hold unit 102, to the reference picture decision unit 112. On the other hand, if the GOP is not determined as a closed GOP, the closed-GOP detection unit 111 outputs the stream information obtained from the stream information hold unit 102, to the coding unit 103, passing through the reference picture decision unit 112 without any processing.

The reference picture decision unit 112 corresponds to a decision unit according to the present invention which decides reference relationships based on the restriction information which is detected by a detection unit. More specifically, the reference picture decision unit 112 decides reference pictures for motion compensation (the reference relationships) based on the information regarding the closed_gop flag and the stream information which are obtained from the closed-GOP detection unit 111.

The coding unit 103 corresponds to a coding unit according to the present invention which codes the picture data decoded by a decoding unit using the second coding method. More specifically, using the H.264 standard that is the second coding method, the coding unit 103 codes the decoded picture which has been decoded and generated by the decoding unit 101.

Here, if the closed-GOP detection unit 111 determines that the GOP is not a closed GOP, the coding unit 103 decides reference pictures based on the stream information obtained from the closed-GOP detection unit 111 and coding parameters in the coding unit 103, and then performs the above coding using the reference pictures decided by the coding unit 103, which is the same manner as the conventional device.

On the other hand, if the closed-GOP detection unit 111 determines that the GOP is a closed GOP, the reference picture decision unit 112 decides reference pictures for motion compensation. This decision is performed by setting a parameter in a syntax, using a closed_gop flag in a GOP header. Among the reference pictures for motion compensation decided by the reference picture decision unit 112 and based on the stream information, the coding unit 103 decides reference pictures to be used, according to coding parameters in the coding unit 103 and codes the decoded picture by the H.264 standard that is the second coding method. Thereby, even in the coding using the H.264 standard that is the second coding method, it is possible to prevent motion estimation beyond GOP boundaries.

Next, the following describes, in more detail, the processing of deciding the reference relationships according to the restriction information for restricting the reference relationships not to refer to picture data beyond a group of pictures which is processed as one set of pictures, when the restriction information is detected out of a part of the picture data coded by the first coding method.

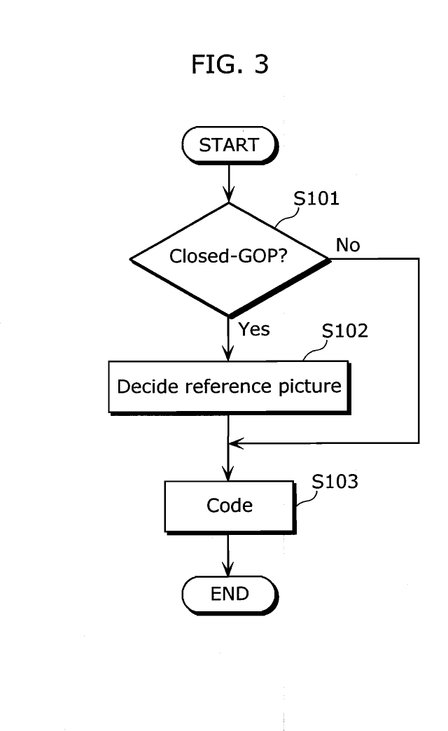

FIG. 3 is a flowchart of the processing performed by the closed-GOP detection unit 111 in the case of where the closed-GOP detection unit 111 determines based on a closed_gop flag that a GOP is a closed GOP and the case where it determines that a GOP is not a closed GOP.

Firstly, the closed-GOP detection unit 111 determines based on the stream information outputted from the stream information hold unit 102 whether or not a stream is a closed GOP (S101).

If the closed-GOP detection unit 111 determines that the GOP is a closed GOP, the closed-GOP detection unit 111 outputs (i) information regarding the closed-gop flag and (ii) the stream information obtained from the stream information hold unit 102, to the reference picture decision unit 112 (Yes at S101).

Next, the reference picture decision unit 112 decides reference relationships for motion compensation (reference pictures) by setting a parameter in a syntax based on the information regarding the closed-gop flag and the stream information (S102).

Next, the coding unit 103 decides reference relationships for motion compensation by setting a parameter in a syntax using (iii) stream information, such as a scan scheme and a coding structure, which is obtained from the reference picture decision unit 112 and (i) the information regarding the closed-GOP flag. Then, based on the decided reference relationships for motion compensation, the coding unit 103 decides reference pictures from coding parameters and codes the decoded picture by the second coding method.

On the other hand, if the closed-GOP detection unit 111 determines that the GOP is not a closed GOP (No at S101), the closed-GOP detection unit 111 outputs the stream information obtained from the stream information hold unit 102, to the coding unit 103, passing through the reference picture decision unit 112 without any processing, in the same manner as the conventional method.

Then, the coding unit 103 codes the decoded picture by the second coding method, based on the stream information, such as a scan scheme and a coding structure, which is obtained from the closed-GOP detection unit 111 (S103). Eventually the processing completes.

The following describes the first embodiment of the present invention in more detail by presenting specific examples.

Firstly, picture types of the MPEG-2 standard and the H.264 standard are explained. The MPEG-2 standard defines three kinds of picture types which are: (1) an Intra-coded Picture (I picture) for which intra-picture coding is performed; (2) a Predictive-coded Picture (P picture) for which intra-picture coding and forward prediction are performed; (3) a Bi-directionally predictive-coded picture (B picture) for which intra-picture coding and forward, backward, and bi-directional prediction are performed. On the other hand, the H.264 standard defines five kinds of picture types which are: (1) an I picture and (2) an Instantaneous Decoder Refresh Picture (IDR picture) for each of which intra-picture coding is performed; (3) a P picture for which intra-picture coding and forward prediction, which is called List 0 Prediction (L0 prediction) in the H.264 standard, are performed; (4) a B picture and (5) a Br picture for each of which intra-picture coding and L0 prediction, backward prediction (List 1 Prediction (L1 prediction) in the H.264 standard), and bi-directional prediction are performed. If an IDR picture is inserted, a status which is necessary in decoding is reset, so that motion compensation can not be performed beyond the IDR picture in coding order. This is a difference between IDR pictures and I pictures. Furthermore, while in the MPEG-2 standard a B picture cannot refer to any other B pictures, in the H.264 standard a B picture can refer to specific B pictures which are defined as Br pictures.

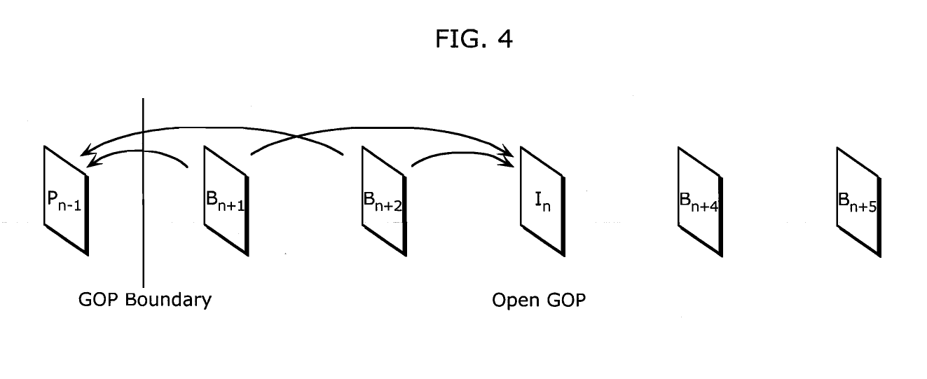

FIG. 4 is a diagram for explaining an open GOP. FIG. 4 is a schematic diagram showing reference relationships regarding B pictures in the case of coding by the MPEG-2 standard, when a closed_gop flag is not set to “1”. If a closed_gop flag in a GOP header is not set to “1”, motion compensation can be performed beyond a GOP boundary. In more detail, as shown in FIG. 4, two B pictures which are positioned in display order prior to an I picture In that is the nth picture can refer to a P picture beyond the GOP boundary. Such a GOP is called an open GOP.

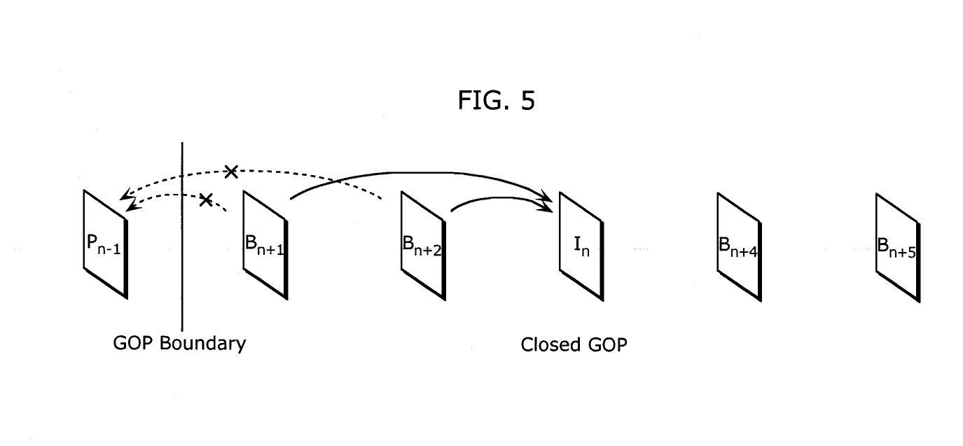

FIG. 5 is a diagram for explaining a closed GOP. FIG. 5 is a schematic diagram showing reference relationships regarding B pictures in the case of coding by the MPEG-2 standard, when a closed_gop flag is set to “1”. If a closed_gop flag in a GOP header is set to “1”, motion compensation is prohibited to be performed beyond a GOP boundary. In more detail, as shown in FIG. 5, two B pictures which are a picture Bn+1 and a picture Bn+2 are restricted not to refer to a P picture beyond the GOP boundary. Such a GOP is called a closed GOP.

The moving picture coding device 100 according to the present invention considers the above restrictions of the MPEG-2 standard even in re-coding by the H.264 standard. Thereby, it is not necessary to refer to pictures which do not inherently need to be referred to, so that a search range of reference pictures is not unnecessarily extended Thereby, it is possible to prevent the problem of increasing a processing amount of motion estimation.

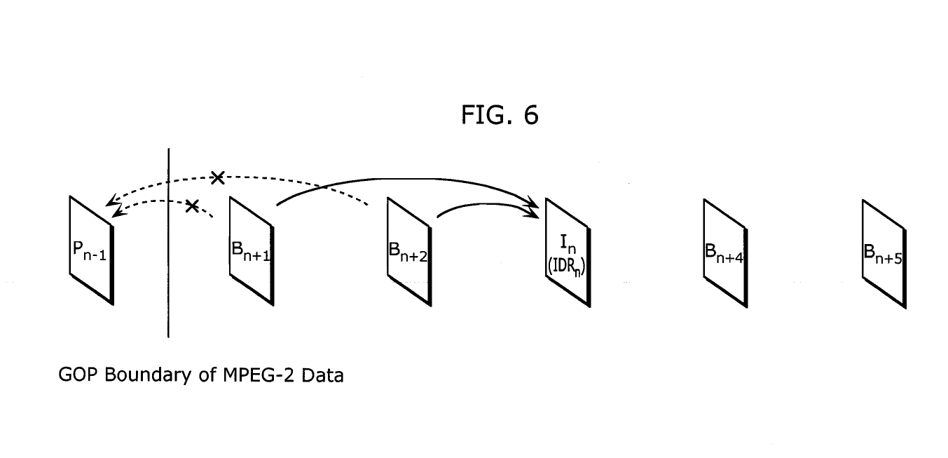

FIG. 6 is a schematic diagram showing reference relationships regarding B pictures in the case where a MPEG-2 stream is coded as a frame structure of the H.264 standard. FIG. 6 conceptually shows reference relationships in the case where a closed_gop flag of the MPEG-2 standard is set to “1” (closed GOP). In the case of an open GOP (No at S101 of FIG. 3), each of two B pictures which are a picture Bn+1 and a picture Bn+2 can refer to both a P picture Pn−1 and an I picture In. However, in the case of a closed GOP (Yes at S101 of FIG. 3), each of the two B pictures Bn+1 and Bn+2 cannot refer to the P picture Pn−1, but can refer to only the I picture In. More specifically, the reference picture decision unit 112 changes setting of parameters in a syntax of the H.264 standard in the following manner. Here, it is assumed that a reference picture numeral of a picture Pn−1 is 0, and that a reference picture numeral of a picture In is 1. For example, in the coding by the H.264 standard, as the first step, parameters ref_idx_l0_active_minus1 and ref_idx_l1_active_minus1 which are in a picture parameter set in a syntax are set to 0. Thereby, in both of the forward prediction (L0) and the backward prediction (L1), an image of one frame can be used as a reference picture (reference frame). At the second step, a reference picture (frame) used in the forward prediction (L0) is set to ref_pic_list_reordering_flag_l0 in a reference picture list reordering syntax, and in order to set the reference picture numeral of the picture Pn−1 to 1, reordering_of_pic_nums_idc is set to 1, and abs_diff_pic_num_minus1 is set to 0. In addition, in order to set the reference picture numeral of the picture In to 0, reordering_of_pic_nums_idc is set to 0, and abs_diff_pic_num_minus1 is set to 0. Thereby, only the picture In whose reference picture numeral is small is referred to. As explained above, in the case of a closed GOP, in actual motion estimation, the coding unit 103 performs motion estimation without referring to the picture Pn−1.

As explained above, by setting parameters in a syntax of the H.264 standard, it is possible to prevent motion estimation beyond GOP boundaries in coding, while conforming the H.264 standard. That is, it is possible to unnecessarily extend the search range of reference pictures (frames).

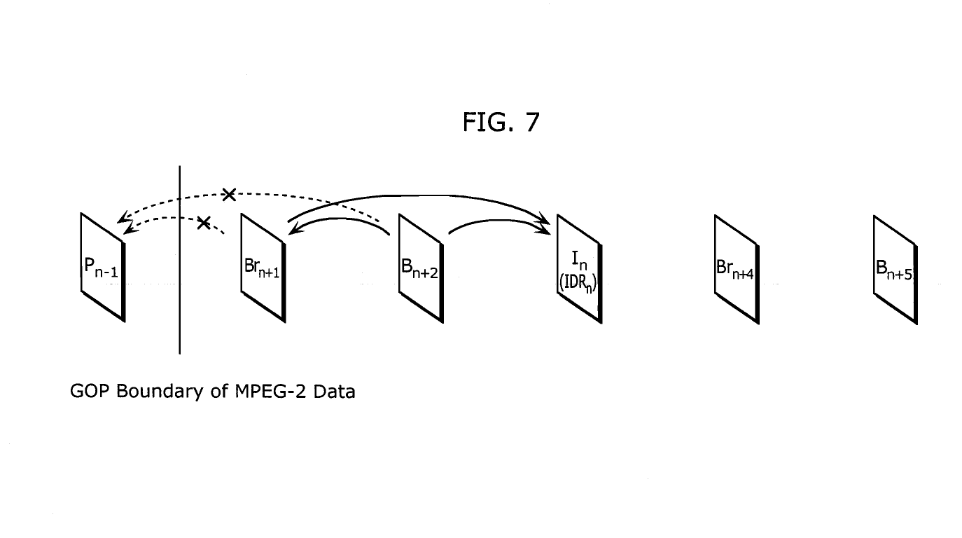

FIG. 7 is a schematic diagram showing reference relationships regarding a Br picture and a B picture in the case where a IvIPEG-2 stream is coded as a frame structure of the H.264 standard. FIG. 7 conceptually shows reference relationships in the case where a closed_gop flag of the MPEG-2 standard is set to “1” (closed GOP). In the case of an open GOP (No at S101 of FIG. 3), each of two pictures Brn+1 and Bn+2 can refer to both a picture Pn-I picture and a picture In. However, in the case of a closed GOP (Yes at S101 of FIG. 3), the picture Brn+1 cannot refer to the picture Pn−1, but can refer to only the picture In. Here, since a B picture can refer to a Br picture, the picture Bn+2 can refer to the picture In and the picture Brn+1. In order to have the above reference relationships active even in the H.264 standard, the reference picture decision unit 112 changes setting of parameters in a syntax of the H.264 standard in the following manner. Regarding the picture Bn+2, a parameter in the forward prediction (L0), ref_idx_l0_active_minus1, is set to 1, so that the picture Bn+2 can refer to two flames. When the picture Bn+2 is coded, num_ref_idx_active_override_flag on a slice header syntax is set, and a value of ref_idx_l0_active_minus1 is changed to 0, so that the picture Bn+2 can refer to one flame (picture) in the forward prediction (L0). Furthermore, in the same manner as described with reference to FIG. 6, reference relationships regarding reference pictures (frames) can be set by setting parameters. In the case of a closed GOP, in actual motion estimation, the coding unit 103 performs motion estimation without using the picture Pn−1 as a reference picture (frames).

As explained above, by setting parameters in a syntax of the H.264 standard, it is possible to prevent motion estimation beyond GOP boundaries in coding, while conforming the H.264 standard. That is, it is possible to unnecessarily extend the search range of reference pictures.

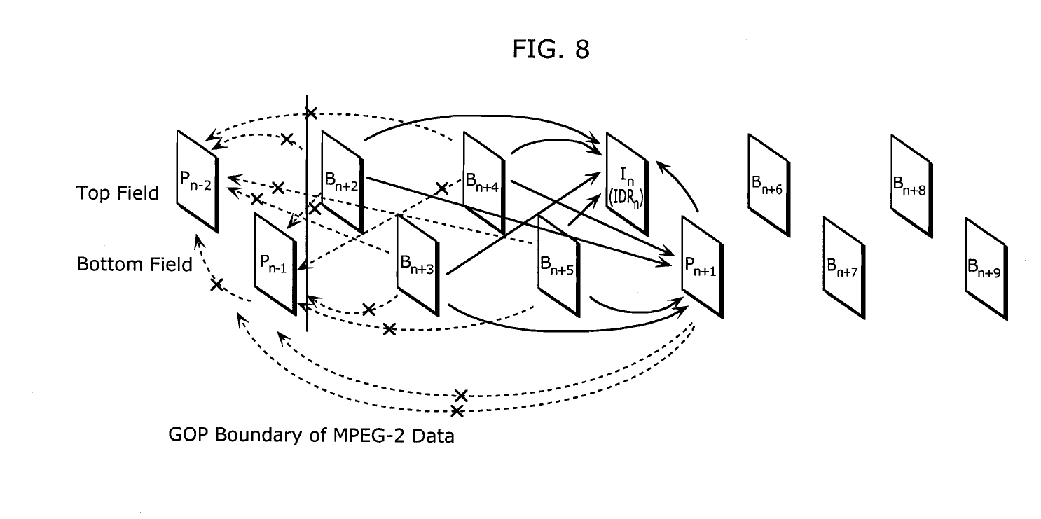

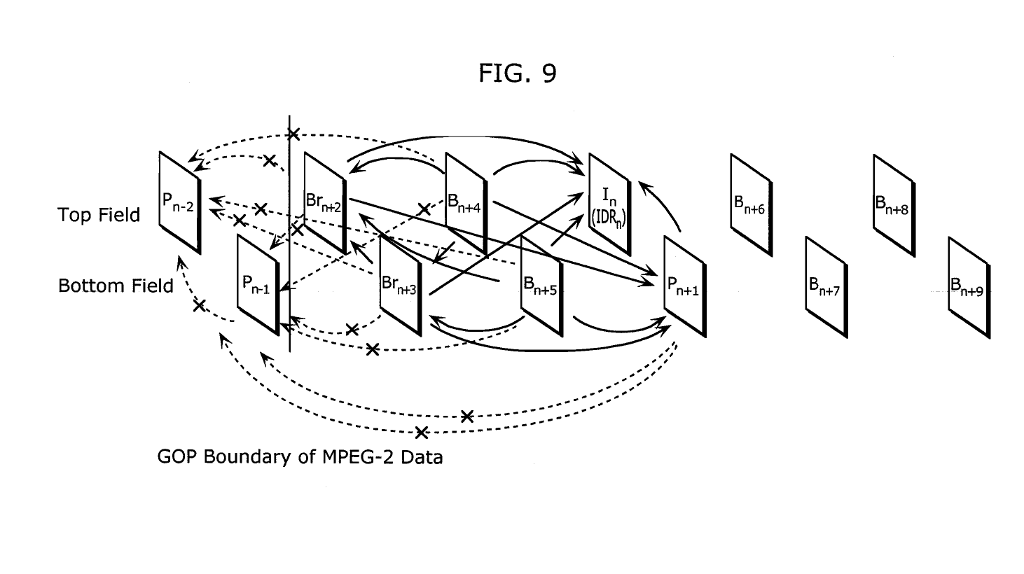

Next, as another example, the following describes the case where a MPEG-2 stream is coded as a field structure of the H.264 standard with reference to FIGS. 8 and 9.

FIG. 8 is a schematic diagram showing reference relationships regarding B pictures in the case where a MPEG-2 stream is coded as a field structure of the H.264 standard. FIG. 8 conceptually shows reference relationships in the case where a closed_gop flag of the MPEG-2 standard is set to “1” (closed GOP).

In the case of the field structure, since reference pictures (fields) can be set on a field-by-field basis, two fields can be set as reference pictures (fields) in each of the forward prediction (L0) and the backward prediction (L1). In the case of an open GOP (No at S101 of FIG. 3), a field Bn+2 can refer to four fields which are a field Pn−2, a field Pn−1, a field In, and a field Pn+1. However, in the case of a closed GOP (Yes at S101 of FIG. 3), each parameter in a syntax of the H.264 standard is changed on a field-by-field basis, so that the field Pn−2 and the field Pn−1 are not referred to beyond a GOP boundary. In the case of a closed GOP, in actual motion estimation, the coding unit 103 performs motion estimation using only the field In and the field Pn+1.

As explained above, by setting parameters in a syntax of the H.264 standard, it is possible to prevent motion estimation beyond GOP boundaries in coding, while conforming to the H.264 standard. That is, it is possible to unnecessarily extend the search range of reference pictures (fields).

FIG. 9 is a schematic diagram showing reference relationships regarding a Br picture and a B picture in the case where a MPEG-2 stream is coded as a field structure of the H.264 standard. FIG. 9 conceptually shows reference relationships in the case where a closed_gop flag of the MPEG-2 standard is set to “1” (closed GOP), and a B field which is a top field of starting fields in the GOP is a Br field. While a field Brn+2 can refer to four fields, a field Brn+3 can refer to total five fields which are the above four fields added with the field Brn+2 since B fields can refer to Br fields. Furthermore, each of a field Bn+4 and a field Bn+5 can refer to total six fields which are the above four fields added with the field Brn+2 and the field Brn+3. In the case of a closed GOP (Yes at S101 of FIG. 3), each parameter in a syntax of the H.264 standard is changed on a field-by-field basis, so that a field Pn−1 and a field Pn−2 are not referred to beyond a GOP boundary. In the case of a closed GOP, in actual motion estimation, the coding unit 103 performs motion estimation using only the field In, the field Pn+1, the field Brn+2, and the field Brn+3.

As explained above, by setting parameters in a syntax of the H.264 standard, it is possible to prevent motion estimation beyond GOP boundaries in coding, while conforming the H.264 standard.

Note that, in FIGS. 8 and 9, it has been described that a top field is the first field in a field pair, the above setting is possible even if a bottom field is used as the first field. Note also that it has been described that a bottom field paired with the I field is a P field, but the bottom field may be an I field.

Thus, according to the first embodiment, it is possible to prevent a search range of the reference pictures from being unnecessarily extended, by prohibiting the motion estimation beyond GOP boundaries set by the MPEG-2 standard. That is, by setting parameters in a syntax of the H.264 standard, it is possible to decide reference relationships for the motion compensation in consideration of restrictions of GOP boundaries set by the MPEG-2 standard in coding of the H.264 standard, which makes it possible to prevent unnecessary motion estimation. Thereby, it is possible to prevent the problem of increasing a processing amount of motion estimation.

### Second Embodiment

The following describes the second embodiment of the present invention with reference to the drawings.

While in the first embodiment the reference relationships for motion compensation are decided by setting parameters in a syntax, in the second embodiment re-coding is performed by setting a starting picture in coding order in a closed GOP to an IDR picture. Thereby, it is possible in the second embodiment to decide the same reference relationships as the reference relationships considered in the first embodiment.

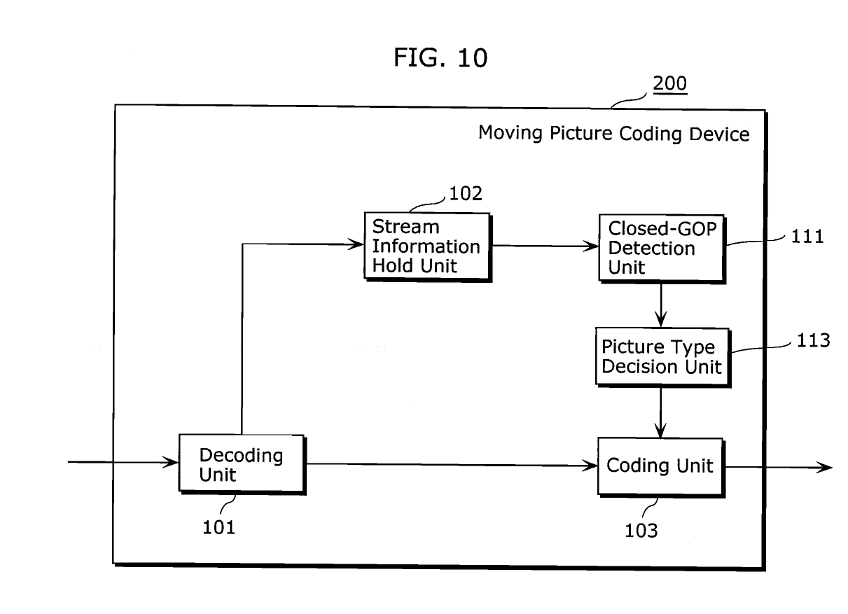

FIG. 10 is a block diagram showing a structure of a moving picture coding device 200 according to the second embodiment of the present invention. As shown in FIG. 10, the moving picture coding device 200 is a device which codes moving pictures, and includes: the decoding unit 101, the stream information hold unit 102, the coding unit 103, the closed-GOP detection unit 111, and a picture type decision unit 113. In the following, the same units are designated by the same reference numerals. The moving picture coding device 200 of the second embodiment differs from the moving picture coding device 100 of the first embodiment in that the reference picture decision unit 112 is replaced by the picture type decision unit 113.

The decoding unit 101 corresponds to the decoding unit according to the present invention which decodes picture data coded by the first coding method. More specifically, when a MPEG-2 stream coded by the first coding method is inputted, the decoding unit 101 decodes the MPEG-2 stream according to a syntax of the MPEG-2 standard. Here, the syntax stands for a rule of data sequence according to the MPEG-2 standard. Furthermore, the decoding unit 101 uses stream information extracted from the MPEG-2 stream in order to generate the decoded picture. The stream information used in the above decoding is, for example, information regarding an entire sequence such as a sequence header, information regarding a GOP such as a GOP header, picture information such as a picture header, slice information such as a slice, macroblock information such as macroblock modes, and the like.

The stream information hold unit 102 holds the extracted stream information. The stream information held in the stream information hold unit 102 is, for example, a bit rate, an image size, a scan scheme, sequence information such as a coding structure, a picture type, motion vector information, information such as a quantization value, and the like.

The closed-GOP detection unit 111 corresponds to a detection unit according to the present invention which detects, out of a part of the picture data coded by the first coding method, restriction information for restricting reference relationships so that reference is not performed beyond a group of pictures which is processed as one set of pictures. More specifically, the closed-GOP detection unit 111 determines whether or not the group of pictures is a closed GOP, based on a closed_gop flag in the stream information held in the stream information hold unit 102.

As shown in FIG. 2, if a closed_gop flag, which is indicated in the third row in the GOP header group_of_pictures_header, is set to “1”, it is indicated that the GOP is a closed GOP.

If the closed-GOP detection unit 111 determines that the GOP is a closed GOP, the closed-GOP detection unit 111 outputs (i) information indicating that the GOP is a closed GOP and (ii) the stream information obtained from the stream information hold unit 102, to the picture type decision unit 113. On the other hand, if the GOP is not determined as a closed GOP, the closed-GOP detection unit 111 outputs the stream information obtained from the stream information hold unit 102, to the coding unit 103, passing through the picture type decision unit 113 without any processing.

The picture type decision unit 113 corresponds to a decision unit according to the present invention which decides reference relationships based on the restriction information which is detected by the detection unit. More specifically, the picture type decision unit 113 decides reference pictures for motion compensation (the reference relationships) based on the information regarding the closed_gop flag and the stream information which are obtained from the closed-GOP detection unit 111, by setting, to an IDR picture, an I picture in a GOP defined in a MPEG-2 bitstream.

The coding unit 103 corresponds to a coding unit according to the present invention which codes the picture data decoded by the decoding unit using the second coding method. More specifically, using the H.264 standard that is the second coding method, the coding unit 103 codes the decoded picture which has been decoded and generated by the decoding unit 101.

Here, if the closed-GOP detection unit 111 determines that the GOP is not a closed GOP, the coding unit 103 decides reference pictures based on the stream information obtained from the closed-GOP detection unit 111 and coding parameters in the coding unit 103, and then performs the above coding using the reference pictures decided by the coding unit 103, which is the same manner as the conventional device.

On the other hand, if the closed-GOP detection unit 111 determines that the GOP is a closed GOP, the picture type decision unit 113 decides reference relationships for motion compensation. This decision is performed by setting an I picture in a GOP to an IDR picture, setting a coding parameter in a syntax using a closed_gop flag in a GOP header. Among the reference pictures for motion compensation decided by the picture type decision unit 113 and based on the stream information, the coding unit 103 decides reference pictures to be used, according to coding parameters and codes the decoded picture by the H.264 standard that is the second coding method. Thereby, even in the coding using the H.264 standard that is the second coding method, it is possible to prevent motion estimation beyond GOP boundaries.

Next, the following describes, in more detail, the processing of deciding the reference relationships according to the restriction information for restricting the reference relationships not to refer to picture data beyond GOP boundaries, when the restriction information is detected out of a part of the picture data coded by the first coding method.

With reference to FIG. 3, description is given for the processing performed by the closed-GOP detection unit 111 including the case where the closed-GOP detection unit 111 determines based on a closed_gop flag that a GOP is a closed GOP and the case where it is determined that a GOP is not a closed GOP.

Firstly, the closed-GOP detection unit 111 determines based on the stream information outputted from the stream information hold unit 102 whether or not a stream is a closed GOP (S101).

If the closed-GOP detection unit 111 determines that the GOP is a closed GOP (Yes at S101), the closed-GOP detection unit 111 outputs (i) information regarding the detected closed_gop flag and (ii) the stream information obtained from the stream information hold unit 102, to the picture type decision unit 113.

Next, the picture type decision unit 113 decides picture types for deciding reference pictures for motion compensation, by setting coding parameters in a syntax of the H.264 standard based on the information regarding the closed_gop flag and the stream information which are obtained from the closed-GOP detection unit 111 (S102).

Next, the coding unit 103 codes the decoded picture by the second coding method, by deciding reference pictures from coding parameters defined by the H.264 standard based on (i) the stream information, such as a scan scheme and a coding structure, which is obtained from the picture type decision unit 113 and (ii) the decided picture types which are used to set coding parameters in a syntax and decide reference relationships for motion compensation (S103).

On the other hand, if the closed-GOP detection unit 111 determines that the GOP is not a closed GOP (No at S101), the closed-GOP detection unit 111 outputs the stream information obtained from the stream information hold unit 102, to the coding unit 103, passing through the picture type decision unit 113 without any processing, in the same manner as the conventional method.

Then, the coding unit 103 codes the decoded picture by the second coding method, based on the stream information, such as a scan scheme and a coding structure, which is obtained from the closed-GOP detection unit 111 (S103). Eventually the processing completes.

The following describes the second embodiment of the present invention in more detail by presenting specific examples with reference to FIGS. 6 to 9.

In FIGS. 6 and 7, each I picture is changed to an IDR picture. Here, the IDR picture is shown with a symbol IDR in parentheses. In the H.264 standard, if an IDR picture is inserted, a status which is necessary in decoding is reset. In other words, pictures following the IDR picture in coding order can be decoded without information of pictures coded prior to the IDR picture. By using the above function, by setting a starting picture in coding order in a closed GOP to an IDR, motion compensation is performed without using pictures prior to the IDR picture. In FIG. 6, the picture Pn−1, the picture Bn+1, the picture Bn+2, and the picture IDRn are sequentially positioned in display order. However, the coding order is different from the display order, and in the coding order, the picture Pn−1, the picture IDRn, the picture Bn+1, and the picture Bn+2 are positioned sequentially, so that each of the picture Bn+1 and the picture Bn+2 cannot refer to the picture Pn−1 according to the restrictions of the H.264 standard. In other words, in the coding by the H.264 standard, the picture type decision unit 113 can consider the restrictions of the MPEG-2 standard, which is the GOP boundary set in the MPEG-2 standard, by setting an I picture in a GOP defined in a MPEG-2 bitstream to an IDR picture. That is, by preventing motion estimation beyond GOP boundaries set by the MPEG-2 standard, motion vectors can be estimated without unnecessarily extending the search range of the reference pictures.

Furthermore, in the second embodiment, it is not necessary to set parameters in a syntax for reference pictures, but it is possible to set a closed GOP only by setting, to an IDR picture, a starting picture in coding order of an picture sequence corresponding to a GOP. More specifically, the picture type decision unit 113 changes the setting of the coding parameters in the following manner. nal_unit_type in a NAL unit syntax is set to 5, so that the first picture in a GOP can be set as a slice data of an IDR picture. The same goes for the case of FIG. 7 using the Br picture.

In the case of the field structure of FIGS. 8 and 9, a closed GOP can be achieved, by setting, to an IDR picture, a starting field in coding order in an picture sequence corresponding to a GOP. In the above case, in the coding order, the field Pn−2, the field Pn−1, the field IDRn, the field Pn+1, the field Bn+2, the field Bn+3, the field Bn+4, and the field Bn+5 are positioned sequentially. Therefore, motion compensation for fields following the field Pn+1 is performed without referring to the field Pn−1 and the field Pn−2. For setting of a syntax, in the above-described manner, nal_unit_type is set to 5, so that a starting picture can be set as a slice data of an IDR picture. Thereby, it is possible to prevent motion estimation beyond the GOP boundaries set by the MPEG-2 standard. The same goes for the case of FIG. 9 using the Br fields.

Note that, in FIGS. 8 and 9, it has been described that a top field is the first field in a field pair, but the second embodiment does not limit to the above and the above setting is possible even if a bottom field is used as the first field. Note also that it has been described that a bottom field paired with the I field is a P field, but the bottom field may be an I field or an IDR field.

Thus, according to the second embodiment, it is possible to prevent the search range of the reference pictures from being unnecessarily extended, by prohibiting the motion estimation beyond GOP boundaries set by the MPEG-2 standard. The above is achieved by setting, to an IDR picture, an I picture in a GOP set in a MPEG-2 stream. Thereby, it is possible to prevent the problem of increasing a processing amount of motion estimation.

Although only some exemplary embodiments of the present invention have been described in detail above, those skilled in the art will be readily appreciate that many modifications are possible in the exemplary embodiments without materially departing from the novel teachings and advantages of the present invention. Accordingly, all such modifications are intended to be included within the scope of this invention.

### INDUSTRIAL APPLICABILITY

The present invention can be used as a moving picture coding device and a moving picture coding method used by the device, and particularly used as a moving picture coding device, such as a digital video recorder, which records high-definition pictures such as high-definition television broadcast using a coding method with high coding efficiency such as the H.264 standard.

What is claimed is:

1. A moving picture coding device which codes moving pictures, said device comprising:
a decoding unit operable to decode picture data coded by a first coding method;
a detection unit operable to detect restriction information out of a part of the picture data coded by the first coding method, the restriction information being used to restrict a reference relationship so that reference is not performed beyond a group of pictures which is processed as one group;
a decision unit operable to decide the reference relationship based on the restriction information, when said detection unit detects the restriction information; and
a coding unit operable to code the picture data decoded by said decoding unit, by a second coding method and based on the reference relationship decided by said decision unit.

2. The moving picture coding device according to claim 1,
wherein said decision unit is operable to decide a parameter which indicates the reference relationship used to estimate a motion vector.

3. The moving picture coding device according to claim 1,
wherein said decision unit is operable to decide to set, to an Instantaneous Decoder Refresh picture, a starting picture in coding order in the group of pictures which is processed as one group.

4. The moving picture coding device according to claim 1,
wherein the first coding method conforms to MPEG-2 standard, and the second coding method conforms to H.264 standard.

5. A moving picture coding method for coding moving pictures, said method comprising:
decoding picture data coded by a first coding method;
detecting restriction information from a part of the picture data coded by the first coding method, the restriction information being used to restrict a reference relationship so that reference is not performed beyond a group of pictures which is processed as one group;
deciding the reference relationship based on the restriction information, when the restriction information is detected in said detecting; and
coding the picture data decoded in said decoding, by a second coding method and based on the reference relationship decided in said deciding.

6. A computer program product for coding moving pictures, said computer program product allows, when loaded into a computer, the computer to execute steps of:
decoding picture data coded by a first coding method;
detecting restriction information out of a part of the picture data coded by the first coding method, the restriction information being used to restrict a reference relationship so that reference is not performed beyond a group of pictures which is processed as one group;
deciding the reference relationship based on the restriction information, when the restriction information is detected in said detecting; and
coding the picture data decoded in said decoding, by a second coding method and based on the reference relationship decided in said deciding.

7. An integrated circuit which codes moving pictures, said integrated circuit comprising:
a decoding unit operable to decode picture data coded by a first coding method;
a detection unit operable to detect restriction information out of a part of the picture data coded by the first coding method, the restriction information being used to restrict a reference relationship so that reference is not performed beyond a group of pictures which is processed as one group;
a decision unit operable to decide the reference relationship based on the restriction information, when said detection unit detects the restriction information; and
a coding unit operable to code the picture data decoded by said decoding unit, by a second coding method and based on the reference relationship decided by said decision unit.
